(19) United States
(12) Patent Application Publication
(10) Pub. No.: US 2008/0296904 A1
(43) Pub. Date: Dec. 4, 2008

(54) System for capturing energy from a moving fluid

(76) Inventor: Nasik Elahi, New City, NY (US)

Correspondence Address: Lance J. Lieberman, Esq.;Cohen Pontani Lieberman & Pavane LLP, Suite 1210, 551 Fifth Avenue, New York, NY, 10176, US

(21) Appl. No.: 12/152,807

(22) Filed: May 16, 2008

Related U.S. Application Data
(60) Provisional application No. 60/932,159, filed on May 29, 2007.

(51) Int. Cl. F03D 9/00; B60K 6/00; F03B 13/00

(52) U.S. Cl. 290/55; 180/65.2

(57) ABSTRACT

An energy recapture system that may be retrofitted to an existing object, such as a vehicle or carrier. The retrofitable system includes means for removably attaching a plurality of wind or fluid driven energy generating modules, such as magnetic or piezoelectric generators, to the exterior of the object, to convert the kinetic energy of a fluid that moves about the object into another kind of energy that may be stored, such as electrical or chemical potential energy. When used to generate chemical potential energy, it is preferred that the kinetic energy of the moving fluid be used to electrolyze a compound such as water into its constituent elements; at least one of these elements, hydrogen and/or oxygen, can be stored for later use in an internal combustion engine associated with the object.

### RELATED APPLICATIONS

This application is a continuation-in-part of my earlier-filed provisional application Ser. No. 60/932,159, filed May 29, 2007, the priority of which is hereby claimed.

### BACKGROUND OF THE INVENTION

1. Field of the Invention

The invention is directed to the field of energy conservation and, more particularly, to devices and systems for capturing kinetic energy from the relative movement of a fluid and an object, and for converting that kinetic energy into another form of energy.

2. Description of the Related Art

The efficient use of energy is one of the most pressing issues facing the world today. Inefficient energy consumption leads to energy overconsumption, which in turn leads to depletion of natural resources, global warming and a host of other difficulties. Still, there is no end in sight for the demand for energy. While many industrialized nations seek to combat energy overconsumption by limiting the use of non-renewable energy sources, developing nations wish to partake in the benefits which may be derived from growing economies and expanding uses of energy.

One of the primary and most widespread consumers of energy is the internal combustion engine, commonly used in cars, trucks, and other motorized vehicles. The internal combustion engine's consumption of fossil fuels is also one of the leading causes of some of the worst ills associated with the overconsumption of energy—such as greenhouse gases—yet society as a whole shows no sign of slowing its reliance thereon.

For example, some automobile manufacturers have begun to sell cars that run exclusively on electricity but these vehicles have, thus far, seen a limited market. Some so-called hybrid vehicles, which use some electricity to reduce their consumption of fossil fuels, are growing in popularity. Hybrid vehicles, and vehicles that use biodiesel or ethanol, however, are not the final word in the development of transportation alternatives relying upon more than the efficient use of the fuels that power the engines. There is an intensive effort underway by government agencies, such as the Department of Energy, and private corporations for alternatives to the use of hydrocarbon fuels. Hydrogen is considered the ideal fuel but it will require decades to establish the infrastructure and support needed to establish hydrogen as a readily available alternative fuel. As a result, rather than wean users away from internal combustion engines, the imperative is to find ways of making fossil fuels use more efficient.

One approach to realizing greater efficiency in the consumption of fossil fuels is found in U.S. Pat. No. 6,740,988 (the disclosure of which is hereby incorporated by reference). In that patent, the inventor describes an energy generation device for mobile carriers, such as automobiles, trains and aircraft. The inventor realized that the movement of the carrier through the surrounding air was a potential source of energy that could be recaptured by the use of energy conversion devices built into the carriers. While the device taught therein may be useful in constructing some new devices, it is limited in its applicability in two significant areas.

First, the device taught therein cannot be applied to existing carriers. That is, the referenced patent offers no guidance in how the device taught therein could be adapted for use with existing cars, trains and aircraft. It would take a long time to retire all existing internal combustion engine vehicles, and, in developing regions with limited financial resources, there would be little incentive to dispose of an existing vehicle just to purchase or deploy a “greener” vehicle. It would therefore be useful if means could be provided to allow for the retrofitting of existing internal combustion vehicles, so that even those with limited financial resources could derive an economic benefit in attaining an improved vehicle with means for recapturing some of the energy currently being lost by existing vehicles.

Second, the device taught in U.S. Pat. No. 6,740,988 is limited to generating a relatively small amount of electrical energy, while in certain applications greater and other forms of energy would be useful.

Yet another prior art apparatus is described in U.S. Pat. No. 6,897,575 (the disclosure of which is also hereby incorporated by reference). In this patent, a removable structure containing turbines is placed on the roof of an electric vehicle to recharge the vehicle's battery. It teaches, however, that using fuel cells to power the vehicle is “not practical”, and further teaches placement of the turbines on the roof of the vehicle, limiting its applicability to electric vehicles.

The prior art also teaches a variety of ways to generate hydrogen onboard vehicles by drawing electrical energy from the vehicle to electrolyze water and then introducing the hydrogen produced by the electrolysis into the air intake of an internal combustion engine. This provides an input of approximately 1% hydrogen as fuel into the engine and thus produces only marginal benefits, which are further eroded when one takes into account the additional energy expended in producing the hydrogen.

There is thus a continuing need in the art for an improved energy recapture conversion, storage and retrieval system which addresses the drawbacks of the prior art.

### SUMMARY OF THE INVENTION

It is accordingly an object of the invention to provide an energy recapture system that can be retrofitted to existing vehicles and carriers to provide means for recapturing energy, located on board the vehicle, and available on demand, without the need to purchase entirely new vehicles or carriers.

It is a further object of the invention to provide an energy recapture system that maximizes the amount of energy recaptured by the movement of a vehicle or carrier through a fluid, by maximizing the surface area of the carrier that is capable of recapturing energy from such movement.

It is yet another object of the invention to provide an energy recapture system that uses the relative movement of a fluid about a vehicle or carrier to convert the kinetic energy of that relative movement into electrical energy which can be used to meet the electrical needs of the vehicle and to also provide chemical potential energy.

It is a still further object of the invention to provide an energy recapture system that uses the relative movement of a fluid about a vehicle or carrier to provide electrical energy to separate a compound, such as water, into its constituent elements. One or both of the elements, for example, hydrogen and oxygen, may then be used as a significant fuel additive to complement the diesel fuel or gasoline in an internal combustion engine to run the engine more efficiently and cleanly.

In accordance with these and other objects of the invention, briefly stated, there is provided an energy recapture system that may be retrofitted onto the surface of an existing object, such as a vehicle or carrier (the body of a truck, trailer, outer surface of containers used in shipping and trucking, the carriages of regular and freight trains and the like). To maximize the recapture, the wind pressure on the front of the moving vehicle is directed through channels which power multiple pods of variable energy producing turbines. Such a retrofitable system, in essence a mobile generating farm, includes means for removably attaching a plurality of energy generating modules or pods, such as wind driven turbines using magnetic or piezoelectric generators, to the exterior of the object, to help convert the kinetic energy of a fluid that moves about the object into another kind of energy that may be stored, such as chemical potential energy. When used to generate chemical potential energy, it is preferred that the kinetic energy of the moving fluid be used to electrolyze a compound such as water into its constituent elements. When this is done, at least one or both of these elements, hydrogen and oxygen, can be used directly or stored in the vehicle, for use on demand in an internal combustion engine associated with the object.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

With reference to the drawings, in which like numerals in the several views represent like elements, there is shown the following:

FIG. 1 is a schematic diagram of an energy recapture system in accordance with the invention;

FIG. 2 is a perspective view of the inventive system deployed horizontally about an existing vehicle, such as a truck;

FIG. 3 is a perspective view of the horizontally aligned inventive system deployed about an existing vehicle, such as a flatbed truck having a container carried thereon;

FIG. 4 is a perspective view of the horizontally aligned inventive system deployed about a bus;

FIG. 5 is a perspective view of the horizontally aligned inventive system deployed about a boat;

FIG. 6 is a perspective view of the inventive system deployed about an automobile;

FIG. 7 is a perspective view of the inventive system deployed about an airplane;

FIG. 8 is a perspective view of the horizontally aligned inventive system deployed about a train;

FIG. 9 is a perspective view of a single removably attachable module in accordance with an embodiment of the invention;

FIG. 10 is an interior view of an energy generating module used with the invention;

FIG. 11 is a perspective view of the exterior of the module shown in FIG. 10, with flaps or shutters to control the entry of the fluid flow into the module;

FIG. 12 is a perspective view of a different energy generating module, primarily for use in the horizontal mode, shown partly in breakaway;

FIG. 13 is a perspective view of one type of arrangement wherein the fluid-driven fan rotor is horizontally aligned with the piezoelectric module that may be used within the inventive system;

FIG. 14 is a perspective view of a second arrangement of piezoelectric generators that utilize a single fluid-driven fan rotor to power two piezoelectric generators that may be used in the inventive system;

FIG. 15 is a perspective view of one type of magnetic electricity-generating module that may be used within the inventive system;

FIG. 16 is a perspective view of a second type of magnetic electricity-generating module that may be used within the inventive system, wherein the fluid-driven fan is vertically aligned with the generator;

FIG. 17 is a perspective view of a third type of magnetic electricity-generating module that may be used within the inventive system;

FIG. 18 is a perspective view of a fourth type of fluid driven magnetic electricity-generating module that may be used within the inventive system;

FIG. 19 is a perspective view of an alternate embodiment of the mobile generating farm of the invention, wherein the fluid-driven fan is vertically aligned with the generator so as to provide lift and/or thrust to the vehicle as it travels; and

FIG. 20 is a perspective view of a single vertically aligned generating pod.

### DETAILED DESCRIPTION OF THE PRESENTLY PREFERRED EMBODIMENTS

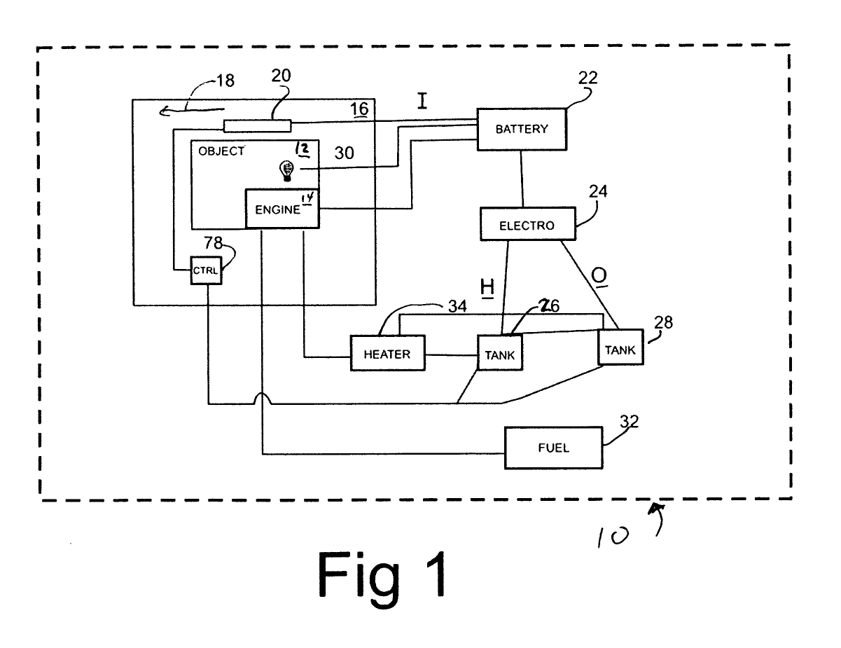

FIG. 1 shows, generally at 10, a schematic diagram of the inventive energy recapture system for use with an object 12, such as a vehicle, e.g., an automobile, a truck, an airplane, a boat or other type of air- or watercraft, or a carrier, e.g., a container carried on a flatbed truck, a non-engine car of a train or other object that is carried, or otherwise moved, by a vehicle. Preferably, object 12 is associated with an engine 14, which is preferably a combustion engine, a hybrid engine or a hydrogen-fuel cell engine, and which is most preferably an internal combustion engine. If object 12 is a vehicle, then engine 14 may be the engine that moves the vehicle. If object 12 is a carrier, then engine 14 may be part of the vehicle that moves the carrier.

Object 12 is disposed within a fluid 16, and there exists relative movement (represented diagrammatically by arrow 18) between object 12 and fluid 16. Object 12, for example, may be moving through fluid 16, as a truck through air or a boat through water. More often, both object 12 and fluid 16 will be moving. For purposes of the invention, what is important is that there exists relative movement between the two, and that this relative movement creates a kinetic energy that may be recaptured by system 10. For ease of description, the following discussion will presume that object 12 moves within fluid 16.

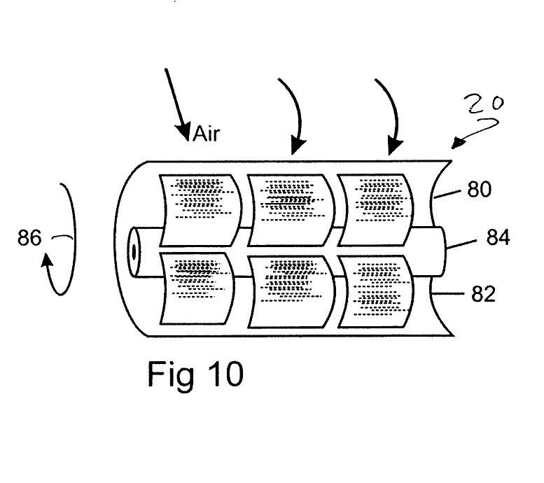

System 10 includes a plurality of energy recapture modules 20 (only one of which is shown here for ease of illustration) disposed about object 12. Modules 20 may be any devices that are capable of translating kinetic energy into another form of energy, for example magnetic motors, turbines or piezoelectric transducers such as described in U.S. Pat. No. 7,005,779 (the disclosure of which is hereby incorporated by reference). Different types of modules 20 and their operation will be discussed below with reference to FIGS. 10-14.

Modules 20 may be used to convert the kinetic energy of fluid 16 as it impinges on the surface of modules 20 to generate an electric current I. Current I flows from modules 20 to storage means 22. Modules 20 may be arranged in either parallel or series to generate the maximum voltage or current, respectively, as required by the particular application. One of ordinary skill in the art would be able to select a suitable arrangement of modules 20 without undue experimentation to satisfy the requirements of any particular application.

If modules 20 are intended to generate electrical power, then storage means 22 may be a battery or other conventional means for storing electrical energy, such as a capacitor. If modules 20 are intended ultimately to generate chemical potential energy, then current I may be used to electrolyze water, for example, in an electrolysis station 24 either immediately or after storage in storage means 22. In this embodiment, electrolysis station 24 would generate two flows of gas, hydrogen H and oxygen O. Each gas would be stored in a separate storage location such as respective tanks 26, 28.

If modules 20 are used to generate electrical power, that power may be used directly by engine 14 to move object 12, or otherwise to drive other devices, such as a light 30 on or within object 12. Excess power may be stored in storage means 22 until needed.

If modules 20 are used to generate chemical potential energy, hydrogen H and oxygen O may be used to power a fuel cell 32, and thereby generate electricity to power engine 14. Fuel cell 32 may be of any desired type, e.g., one consisting of anodes and cathodes separated by a proton exchange membrane (PEM), such as described in U.S. Pat. No. 7,074,509 (the disclosure of which is hereby incorporated by reference); alkaline fuel cells (AFC); phosphoric acid fuel cells (PAFC); solid oxide fuel cells (SOFC); molten carbonate fuel cells and the like.

Alternatively, hydrogen H and/or oxygen O may be used as a fuel or fuel additive and sent directly to engine 14 to decrease the consumption of gasoline by engine 14, and enable engine 14 to run more cleanly, as is known. One enrichment technique having a gas combining unit is shown in U.S. Pat. No. 7,100,542 (the disclosure of which is hereby incorporated by reference). Another technique employing an adapted manifold fitted into a standard fuel injector to servo-controlled channels that feed both hydrogen and oxygen into each cylinder along with liquid fuel is shown in U.S. Pat. No. 6,988,492 (the disclosure of which is hereby incorporated by reference). It is known that heated water is a more efficient source of electrolytic hydrogen H. Accordingly, the supply of water is preferably heated by a heater 34 (which may simply be an existing part of the vehicular cooling system) before feeding into the electrolytic cell. The electrolyzer may consist of a stack of electrolytic cells which are sequentially charged to produce higher volumes of gases in conjunction with increased electrical energy generated by the variable speed generating units as the vehicle speed increases. If only hydrogen H is used as a fuel for engine 14 rather than fuel cell 32, then it may not be necessary to store all or part of oxygen O, and unused or extraneous or unused oxygen O may be discharged to the environment, thereby lessening the equipment (and weight) associated with storing oxygen O. If this alternative is selected, then the oxygen necessary to combine with the hydrogen used in engine 14 may be captured from ambient atmosphere when needed, rather than incurring the expense and weight necessary to store the oxygen generated by electrolysis station 24.

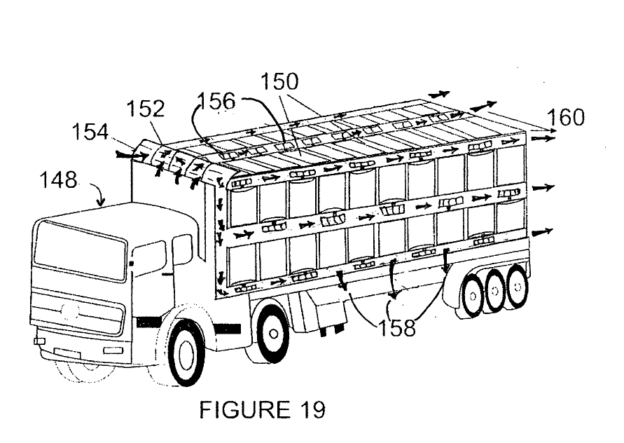

Preferably, modules 20 are disposed about the maximum possible surface of object 12 that is exposed to the movement of fluid 16. In the case of a moving vehicle, this means that modules 20 are positioned about object 12 so that the surfaces of modules 20 that react with the moving fluid are aligned, either horizontally or vertically, as may be appropriate, with the expected direction of the relative movement between object 12 and fluid 16. Additionally, modules 20 may be arranged so that the air that exits therefrom may provide at least one of lift and thrust to object 12, as shown below with respect to FIG. 19, as may be required by the application, thereby providing additional fuel savings.

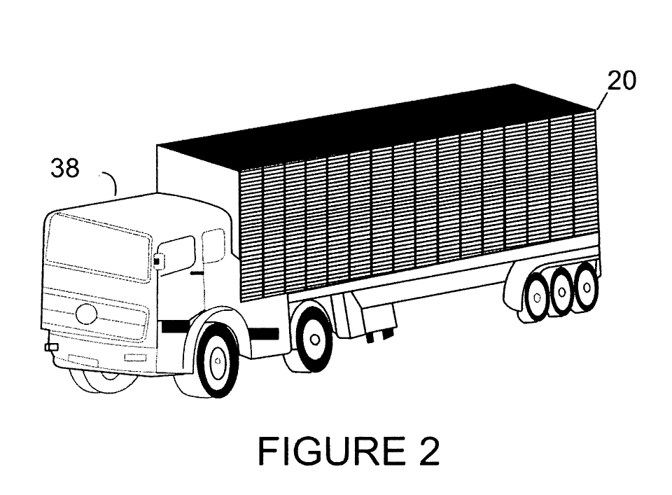

A preferred embodiment of system 10 is shown in FIG. 2, in which system 10 is deployed in connection with a truck 38. As will be seen, modules 20 are arrayed about the exterior of truck 38 on the top and sides thereof, so that the longitudinal axis of each module 20 is aligned with the expected direction of movement of truck 38. In this embodiment, storage means 22 and/or tanks 26 and 28, together with the other components of system 10, may be located either within the cab area of truck 38 or in the back of truck 38, as a matter of design choice.

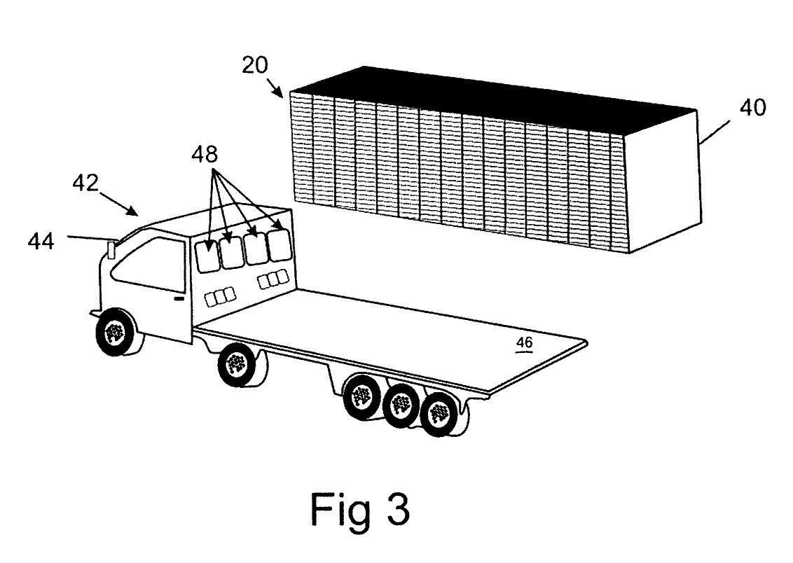

A further embodiment of the inventive system is shown in FIG. 3, in which the object is a container 40 carried on a flatbed truck 42 having a cab 44 and a flatbed 46. Truck 42 may be used to carry any kind of load, and so need not have modules 20 arrayed thereon. Rather, modules 20 may be placed on the object, container 40, carried on flatbed 46. In this embodiment, it is preferred that all components of system 10 other than modules 20 be located within cab 44, so that the components of system 10 do not have to be duplicated for each container 40. Accordingly, the rear of cab 44 preferably has means for receiving the electricity generated by modules 20, such as contacts 48 (not drawn to scale), adapted to receive electricity from mating contacts (not shown) on container 40 or through a connector, such as a plug. A similar arrangement could be utilized if object 12 were a tractor trailer. The electrolytic unit in this and other configurations may consist of a stack of electrolyzers which are sequentially charged by the increasing electrical energy of the variable speed generators under the higher speed of the vehicle; the excess hydrogen and oxygen can be stored for subsequent use.

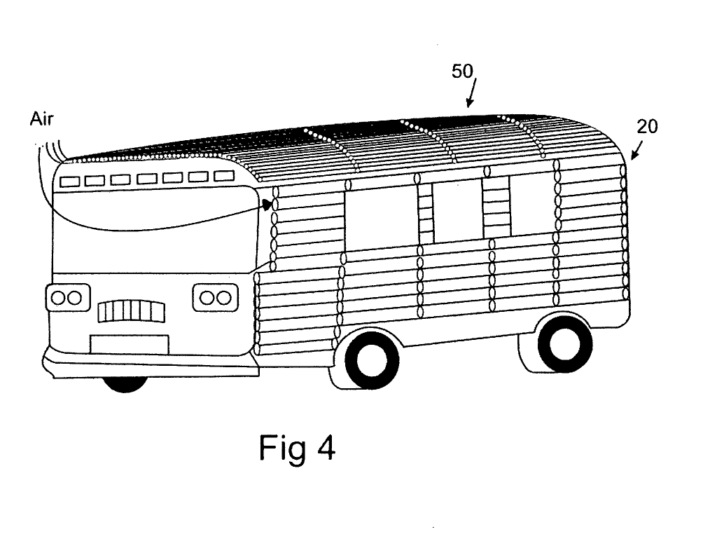

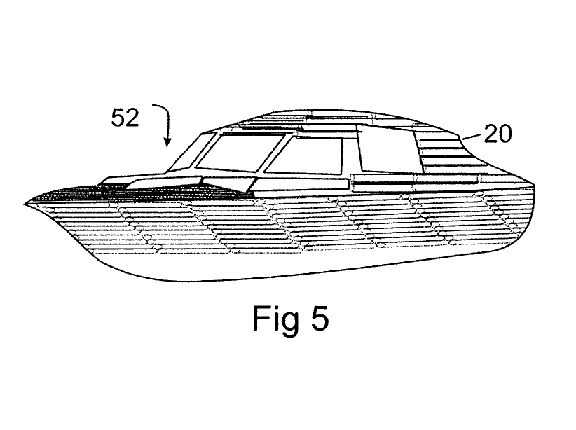

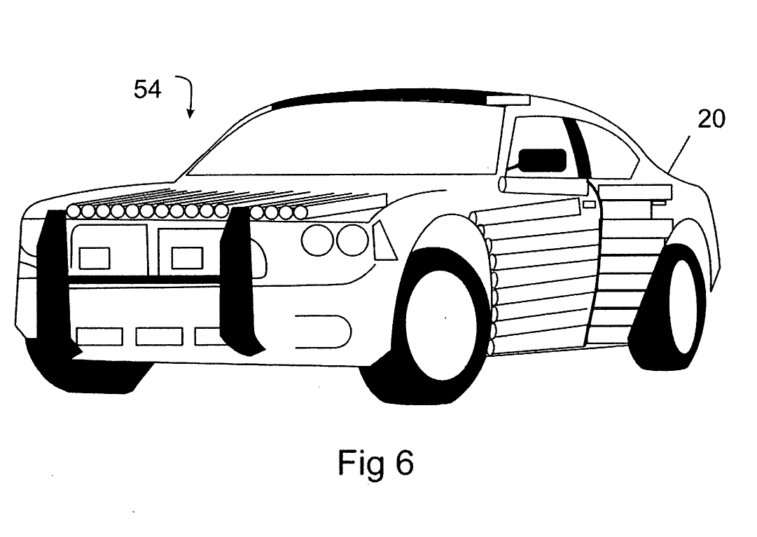

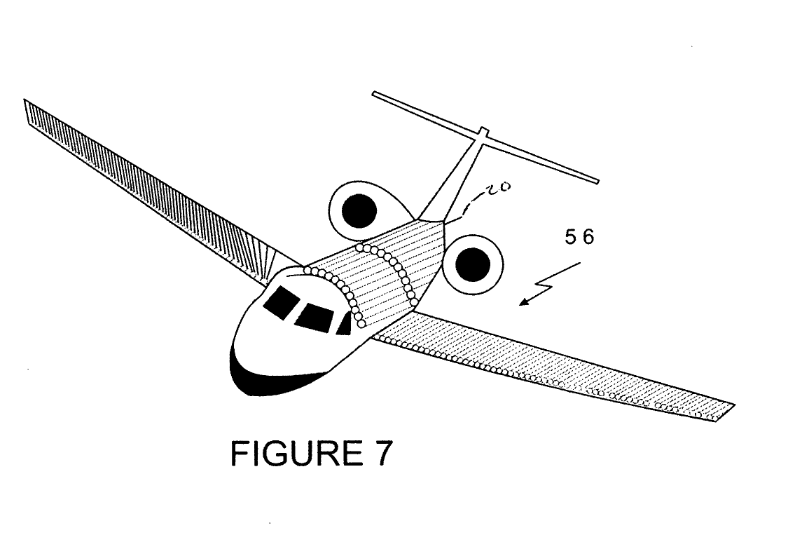

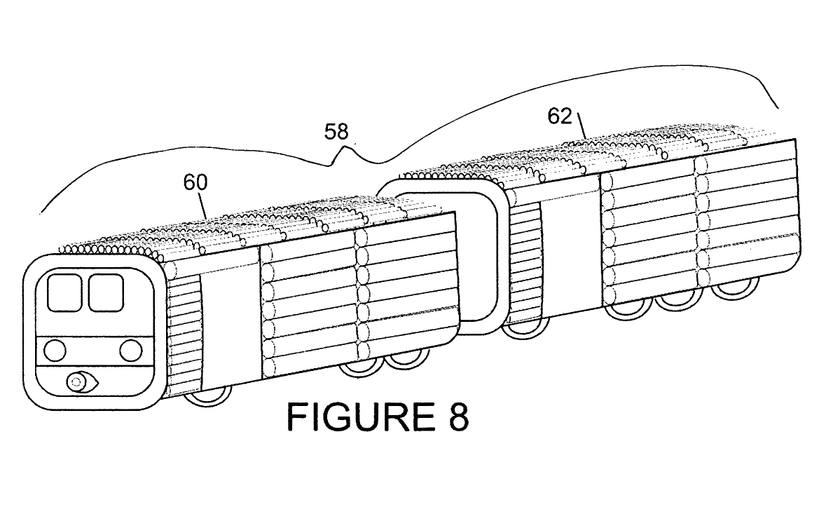

Other embodiments of the invention are seen in FIGS. 4-8, in which the inventive system is shown in use with a bus 50 (FIG. 4), a boat 52 (FIG. 5), an automobile 54 (FIG. 6), an airplane 56 (FIG. 7) and a train 58 having an engine car 60 and at least one non-engine (e.g., passenger or freight) car 62 (FIG. 8).

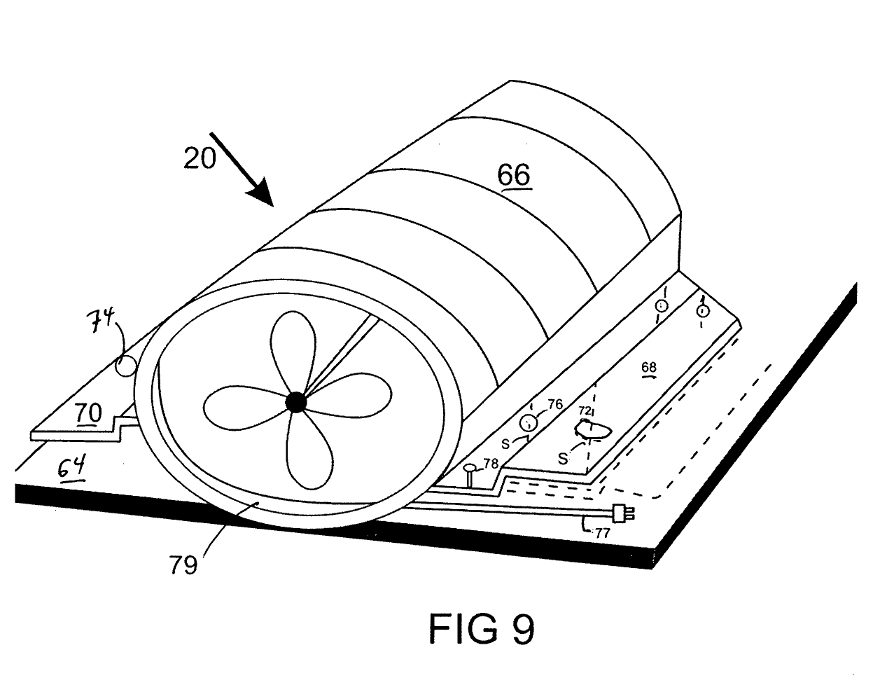

A feature of the inventive system is shown in FIG. 9. As stated, it is possible to retrofit system 10 to existing vehicles and carriers, rather than simply constructing new vehicles and/or carriers in accordance with the invention. In such an embodiment, modules 20 must be attached to the vehicle or carrier, and may be attached to the vehicle or carrier in any desired fashion. Modules 20 may be connected to one another in any conventional manner as may be suitable for any particular application. The manner of attachment and connection is a mere matter of design choice, and the selection of appropriate means for accomplishing these ends is well within the skill of one of ordinary skill in the art. A preferred embodiment of the invention that includes suitable means for removably attaching modules 20 to an object 64 is shown in FIG. 9. Here, object 64 is the surface of any sort of vehicle or container.

In the embodiment illustrated in FIG. 9, module 20 comprises channel 66, formed as a generally cylindrical housing 66 for guiding fluid 16 into module 20. Housing 66 includes first and second stepped flanges 68 and 70, respectively, with respective first and second slots 72 and 74. First and second stepped flanges 68 and 70 are configured to mate so that first slots 72 of first flange 68 line up with second slots 74 of second flanges 70 of an adjacent module 20, thereby allowing adjacent modules 20 to be secured to one another in an overlapping relationship. Further holes 76 may be provided for screws S (shown diagrammatically as dashed vertical lines) to attach module 20 to object 64. Other screws S may attach adjacent modules 20 to one another, and may even extend all the way to object 64 to provide additional means to secure module 20 thereto. Each module 20 has a connector 77 for coupling to adjacent modules 20, so that modules 20 may be coupled in either parallel or series relations to generate the energy recaptured thereby as a voltage or a current, as may be desired.

In some applications, such as where the inventive system is used on a vehicle operating under extreme weather conditions or when the vehicle is not in use, it may be desirable to provide means for selectively closing all or part of modules 20 to minimize the possibility of damaging the generating units. Under these circumstances, it may be preferred that at least some modules 20 be closed, depending upon the relative velocity of object 12 and fluid 16. To this end, a control device for the flaps to control the flow and prevent the entry of snow or large particles or by closing against the elements 78 (FIGS. 1 and 9) may be provided.

Control device 78 may be deployed to sense the relative movement between object 12 and fluid 16. Based on the speed of that relative movement, control device 78 may selectively close all or some modules 20 (for example with an adjustable iris 79—FIG. 9), to optimize the amount of energy recaptured by system 10. Control device 78 may also control the amount of hydrogen H and/or oxygen O injected into engine 14, depending upon the relative speed of object 12 and fluid 16, where the desired amounts of hydrogen H and oxygen O are delivered regardless of the speed of the vehicle; the excess gases are routed for storage while at lower speeds or in stop and go traffic the gases may be retrieved from storage for use.

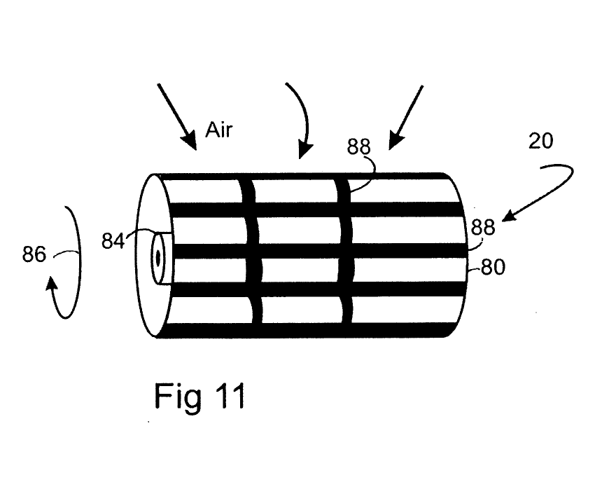

Preferred embodiments of modules 20 are shown in FIGS. 10-12. A single module 20 is shown in FIG. 10. In this embodiment, module 20 is designed as a tube or pod 80 having fitted air driven fins 82 to rotate multi-stage impellers around a magnetic core 84 in a direction shown by arrow 86 such that pods 80 can generate electricity at any wind speed. As an alternative to fins 82, pod 80 may employ ram air turbines, paddle wheels or any other known device for generating electricity from wind, as a matter of design choice. As shown in FIG. 11, pod 80 may be protected by baffles 88 or other suitable forms of interlocking covers when not in use, for example by the operation of control unit 78 as described above. Openings between baffles 88 may create channels therebetween to direct the flow of air onto fins 82 (FIG. 10) to cause fins 82 to rotate and thereby generate electricity.

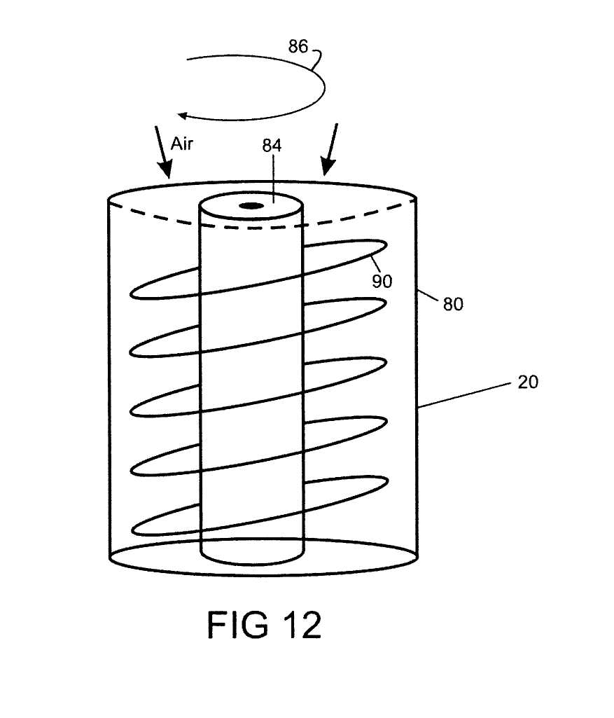

An alternate embodiment of pod 80 is shown in FIG. 12 in which angled blades 90 are positioned about core 84 to rotate in response to the impingement of air thereon.

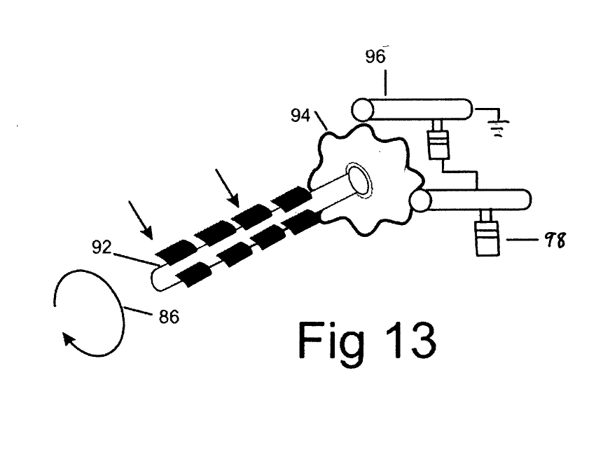

A further embodiment of modules 20 is shown in FIG. 13, in which a rotating shaft 92 is operatively associated with at least one cam 94, so that impingement of air on shaft 92 causes shaft 92 to rotate (arrow 86), thereby rotating cam 94. Cam 94 interacts with push rods 96 which drive respective spring-mounted piezoelectric stack assemblies 98 to generate electricity in known fashion. Suitable power generators using piezoelectric materials are shown, for example, in U.S. Pat. No. 7,005,779 (the disclosure of which is hereby incorporated by reference).

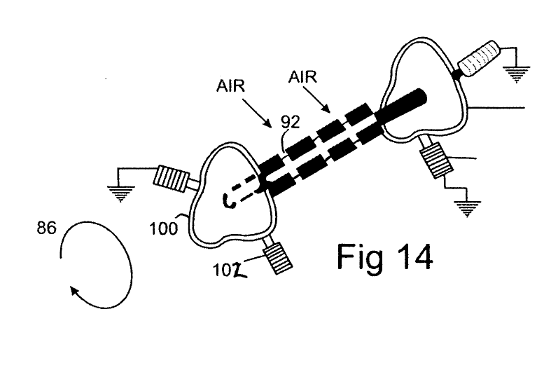

An alternate embodiment of the arrangement of FIG. 13 is shown in FIG. 14, in which one cam 100 directly drives two piezoelectric devices 102 simultaneously.

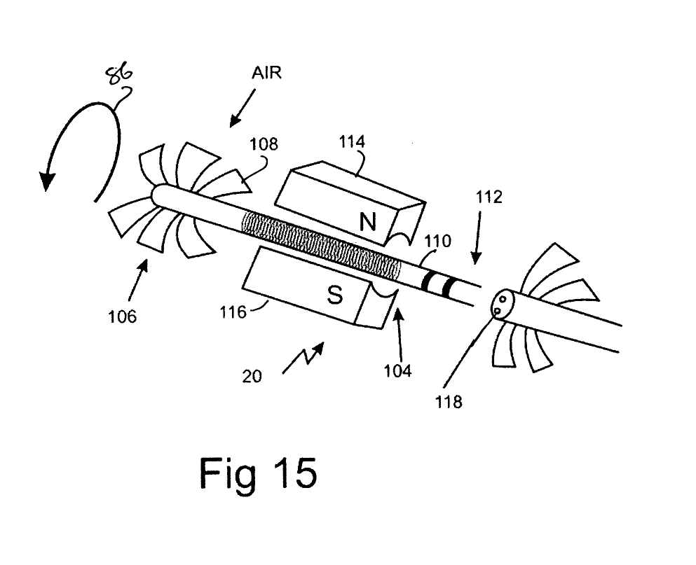

FIGS. 15-18 illustrate differing types of magnetically driven modules 20.

FIG. 15 illustrates module 20 as a simple synchronous generator module 104. Module 104 includes a wind driven shaft 106 having a plurality of blades 108 on one end thereof, a wire 110 in the middle thereof, and pins 112 on the end thereof opposite blades 108. Shaft 106 is rotatable between a pair of opposed magnets 114, 116. When wire 110 rotates through the magnetic field generated by magnets 114 and 116, it generates a current which may be used to recapture the kinetic energy from the wind that blows on fins 108. Pins 112 are configured to mate with holes 118 on an adjacent shaft 106′, so that the multiple shafts 106, 106′ may rotate in tandem.

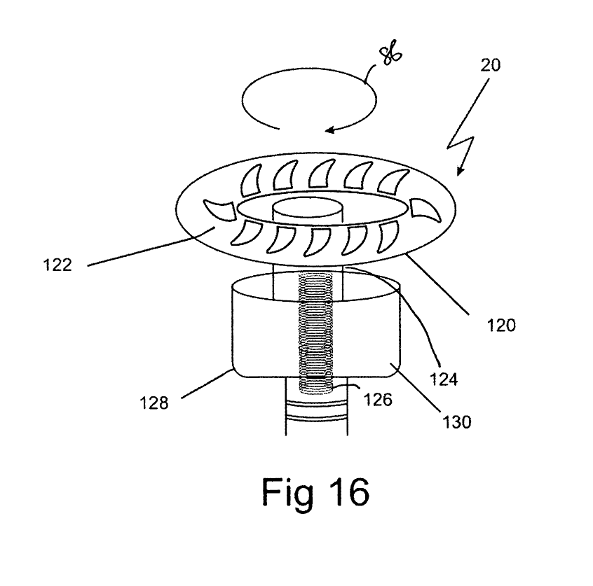

An alternate embodiment of module 20 is shown in FIG. 16, in which module 20 is a synchronous generator pod 120 with an air driven rotary head 122. Rotary head 122 is attached to a shaft 124 containing a wire 126 disposed within a magnetic field generated by magnets 128, 130. In this embodiment, air impacts on rotary head 122, causing it to turn, leading to wire 126 rotating in the magnetic field, thereby generating an electric current in wire 126. That current may then be used in any fashion described above.

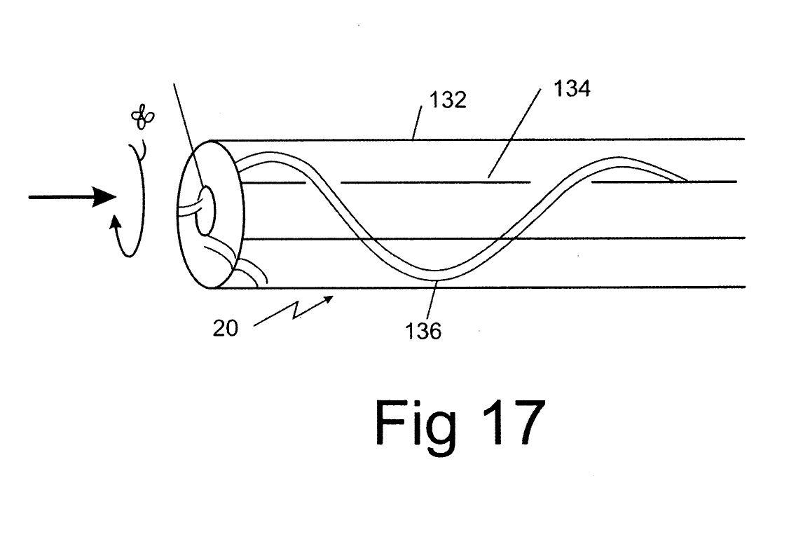

A still further embodiment of module 20 is shown in FIG. 17, in which module 20 is a synchronous generator pod 132 having a vertical shaft 134 with a rotary fin 136. Shaft 134 is magnetic, and the impingement of air on rotary fin 136 causes shaft 134 to rotate, thereby generating a current in a stationary wire in the field of shaft 134, as is known.

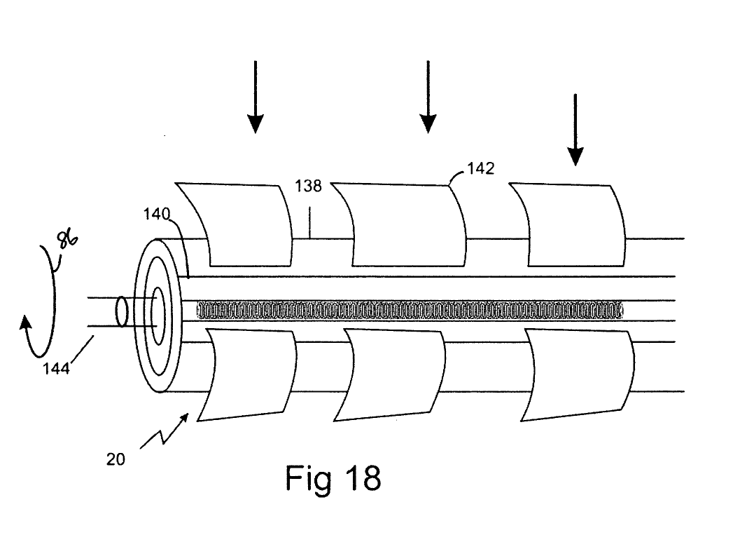

Yet another embodiment of module 20 is shown in FIG. 18, in which module 20 is a synchronous generator 138 with a horizontal air driven design. Module 20 includes a shaft 140 and baffles 142 forming channels therebetween for guiding air into generator 138. Shaft 140 further includes pins 144 for insertion into holes (not separately shown) in an adjacent shaft 140, so that adjacent shafts 140 may move in tandem. Shaft 140 further includes a wire 146 that rotates in a magnetic field (not separately shown) generating a current therein which is used as hereinbefore described.

As will be appreciated by those of ordinary skill in the art, various combinations of generators may be used in any particular installation as the needs of the application may dictate, and the selection of suitable components is well within the ability of those of ordinary skill in the art and may be performed without undue experimentation.

In addition, as shown in FIG. 19, the vertical and horizontal placement of the modules about the vehicle may provide added benefits of fuel savings, by providing additional thrust and/or lift to the moving vehicle. Illustrated in FIG. 19 is a truck 148 having a plurality of modules 150 disposed on the exterior thereof. Channels 152 on the exterior surface of truck 148 direct air passing over the exterior of truck 148 (shown by arrows 154) to contact fans 156 disposed in channels 152. In this embodiment, modules 150 are depicted as fan-driven electromagnetic generators, such as described above, although any other kind of suitable generator (such as piezoelectric generators) may also be used as a matter of design choice. Channels 152 are narrowing channels, i.e., they have a wider cross-section towards the front of truck 148 than they do at the rear thereof, so that, when the air exits channels 152, it may provide one or both of lift and thrust, as indicated by arrows 158 and 160, respectively. As shown, the number of channels 152 is a matter of design choice, with an increase in the number of channels resulting in an increase in the amount of energy recaptured via the inventive system.

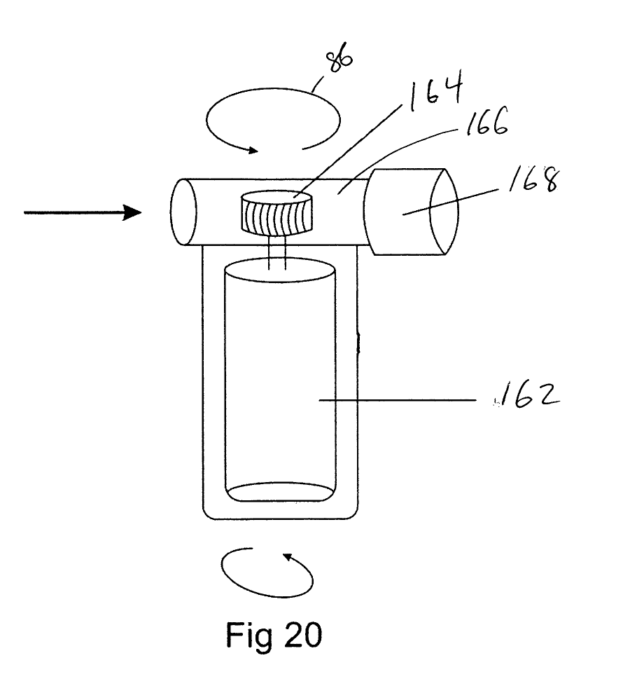

FIG. 20 shows a single vertically aligned generating pod having a module 162 with a fan 164 disposed in channel 166, and an air chamber 168 that may be linked into a similar air chamber of an adjacent module, to chain together a series of such modules as shown above.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An energy recapture system configured for retrofit installation to an existing movable object associated with an engine for operatively moving the object and engine, the object being positionable for movement at least partly in a fluid, for relative movement between the fluid and the object, the system comprising:
a plurality of energy generating modules;
means for removably attaching said plurality of energy generating modules to at least two sides of the object; and
each of said energy generating modules including means for receiving the fluid and means for converting kinetic energy from the relative movement between the fluid and said object to chemical potential energy;
wherein said plurality of energy generating modules is arranged to maximize the amount of chemical potential energy generated by the conversion of the kinetic energy.

2. The system of claim 1, further comprising means for selectively operating at least one of said plurality of energy generating modules.

3. The system of claim 2, wherein the selection of said at least one of said plurality of energy generating modules is performed automatically as a function of a difference in speed of the relative movement between the object and the fluid.

4. The system of claim 1, wherein said energy generating modules include means for converting a chemical compound into at least two constituents.

5. The system of claim 4, wherein said compound is water.

6. The system of claim 4, further comprising means for storing at least one of said constituents.

7. The system of claim 4, further comprising means for injecting at least one of said constituents into the engine to facilitate operation of the engine.

8. The system of claim 4, further comprising means for warming said compound prior to said conversion into its constituents.

9. The system of claim 1, further comprising channels for directing the fluid to said energy generating modules.

10. The system of claim 1, wherein said modules are oriented with respect to the object so as to provide at least one of thrust and lift to the object relative to the fluid.

11. The system of claim 1, wherein the object is selected from the group consisting of an automobile, a truck, a container disposed on a truck, a bus, a train, a car of a train, a boat and an aircraft.

12. The system of claim 1, wherein the engine is selected from the group consisting of an internal combustion engine, a hybrid engine and a fuel cell engine.

13. The system of claim 1, wherein said plurality of energy generating modules are attached to the top and at least one other side of the object.

14. A system for generating energy, for use in moving on object through a fluid, the system comprising:
a plurality of energy generating modules;
means for attaching said plurality of energy generating modules to the object, the object being adapted to be at least partly in the fluid, and being positionable for operating the modules by relative movement between the object and the fluid;
each of said energy generating modules including means for receiving the fluid and means for converting kinetic energy from the relative movement between the fluid and the object to chemical potential energy, by converting a compound into at least two constituents;
means for storing at least one of said constituents; and
means for conducting said at least one of said constituents to an engine associated with the object for enhancing the performance of the engine for moving the object through the fluid.

15. The system of claim 14, wherein said means for attaching comprise means for removably attaching said plurality of energy generating modules to the object.

16. The system of claim 14, wherein said compound is water, and wherein said at least one constituent is hydrogen.

17. The system of claim 16, further comprising means for selectively operating at least one of said plurality of energy generating modules.

18. The system of claim 17, wherein the selection of said at least one of said plurality of energy generating modules is performed automatically as a function of a difference in speed of the relative movement between the object and the fluid.

19. The system of claim 14, further comprising means for injecting at least one of said constituents into the engine to facilitate operation of the engine.

20. The system of claim 14, wherein the engine is selected from the group consisting of an internal combustion engine, a hybrid engine and a fuel cell engine.
